(19) United States
(12) Patent Application Publication
(10) Pub. No.: US 2009/0282644 A1
(43) Pub. Date: Nov. 19, 2009

(54) Cleaning device using an air gun

(76) Inventor: Gerard Therrien, St-Apollinaire (CA)

Correspondence Address: Eric Fincham, 316 Knowlton Road, Lac Brome, QC, J0E 1V0, CA

(21) Appl. No.: 12/387,334

(22) Filed: Apr. 30, 2009

(30) Foreign Application Priority Data
May 14, 2008 (CA) 2,631,283

(51) Int. Cl. B08B 5/02; B05B 1/28

(52) U.S. Cl. 15/422.1; 239/291; 134/37

(57) ABSTRACT

An accessory for use with an air gun to effect particulate pick-up on a surface comprising a flexible member having one end fitted about the end of the air gun and with the other end having a substantially larger opening. The air gun is operated and the second opening is kept close to the surface to be cleaned such that particulate matter is forced upwardly into the flexible member from where it may subsequently be discharged.

### FIELD OF THE INVENTION

The present invention relates to air guns and more particularly, relates to a method for cleaning an area using an air gun and to a device for use in practicing the method.

### BACKGROUND OF THE INVENTION

The use of compressed air in most industrial settings is wide spread and particularly so in the case of manufacturing operations. With its wide availability, many workers take to using the compressed air as a cleaning tool. While this is effective, it also poses a substantial health risk particularly with regard to the danger to the eyes of the operator or bystanders by small particles which are entrained in the air. The danger has become so prevalent that many companies severely limit the practice and indeed, in some jurisdictions it is prohibited.

Naturally, it would be desirable if there was a method and device which would render safe the cleaning of a substrate using compressed air.

### SUMMARY OF THE INVENTION

According to the present invention there is provided a method for cleaning using compressed air and which method substantially prevents a blowing around of small particles.

In a further embodiment of the present invention, there is also provided a method for cleaning using compressed air.

According to one embodiment of the present invention, there is provided, in combination, an air gun and an accessory therefore, the accessory comprising a flexible member having an outer wall, a neck, and a base, a first opening in the neck and a second opening in the base, the second opening being substantially larger than the first opening, the air gun extending through the first opening.

In a further embodiment of the present invention there is provided an accessory for an air gun, the accessory comprising a flexible member having an outer wall, a neck, and a base a first opening in the neck and a second opening in the base, the second opening being substantially larger than the first opening.

In a still further embodiment of the present invention there is provided a method for cleaning particulate matter from a surface comprising the steps of supplying an air gun, placing a flexible member about an end of the air gun, the flexible member having a neck and a base, a first opening in the neck through which the air gun extends, and a second opening in the base, the second opening being substantially larger than the first opening and operating the air gun while keeping the second opening proximate the surface to be cleaned such that the particulate matter will be forced upwardly within the flexible member.

The accessory or device may be part of any suitable flexible material such as a rubber material or polymeric material. The configuration of the device can be varied as will be discussed in the individual embodiments. One convenient device uses a stepped side wall.

### BRIEF DESCRIPTION OF THE DRAWINGS

Having thus generally described the invention, reference will now be made to the accompanying drawings, in which:

FIG. 1 is a side elevational view of a device according to the present invention;

FIG. 2 is a bottom plan view thereof;

FIG. 3 is a side elevational view illustrating use of the device with an air gun;

FIG. 4 is a side elevational view of a further embodiment of the device;

FIG. 5 is a side elevational view of a further embodiment thereof;

FIG. 6 is a side elevational view of a further embodiment thereof;

FIG. 7 is a side elevational view of a further embodiment thereof;

FIG. 8 is a side elevational view of a further embodiment thereof;

FIG. 9 is a side elevational view of a further embodiment thereof;

FIG. 10 is a side elevational view of a further embodiment thereof; and

FIG. 11 is a side elevational view of a further embodiment thereof.

### DETAILED DESCRIPTION OF THE INVENTION

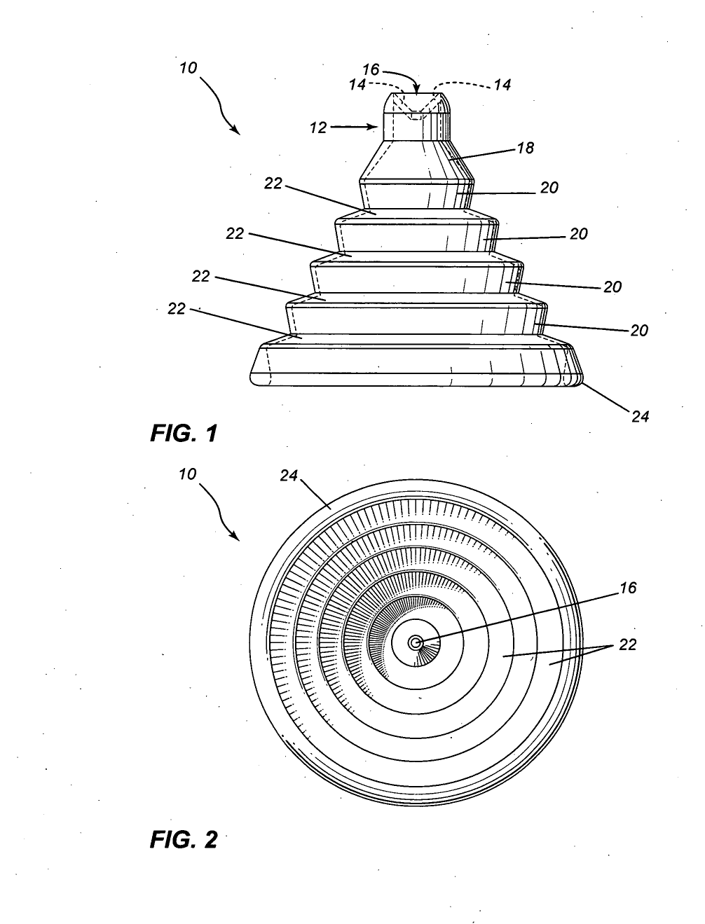

Referring to the drawings in greater detail and by reference characters thereto, there is illustrated in FIGS. 1 and 2 a first embodiment of a device according to the present invention and which device or accessory is generally designated by reference numeral 10.

Device 10 is formed of a flexible bendable material such as rubber or a polymeric material. In the illustrated embodiment, device 10 has a neck 12 with a sealing flange 14 extending inwardly at the top and an aperture 16 being formed in sealing flange 14.

From neck 12, there is provided an outwardly tapering wall section 18. At the end of outwardly tapering wall section 18, there are provided a plurality of steps comprised of vertical wall sections 20 and substantially horizontal wall sections 22. They terminate in a base 24.

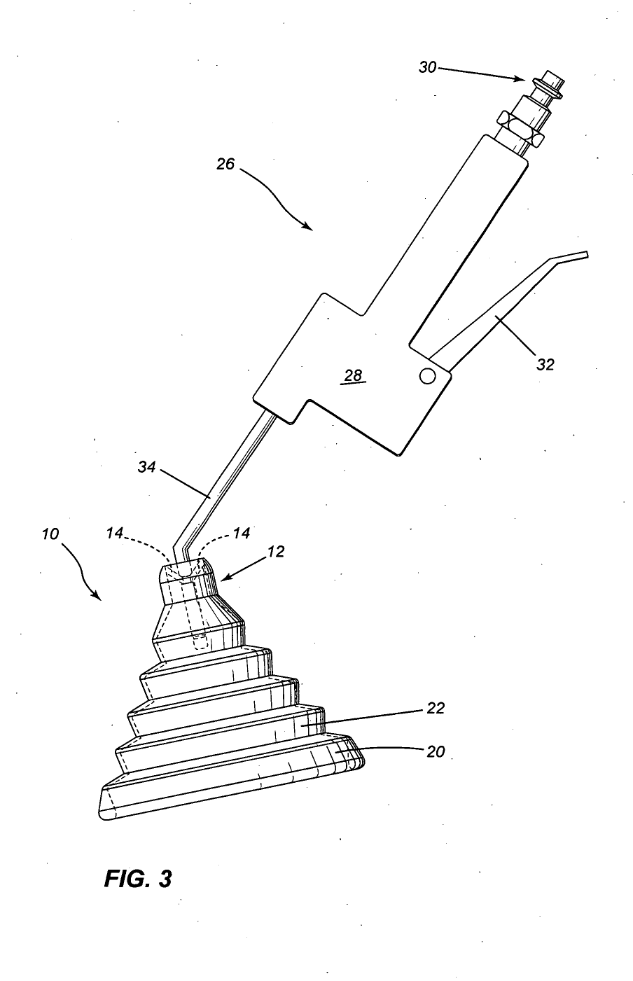

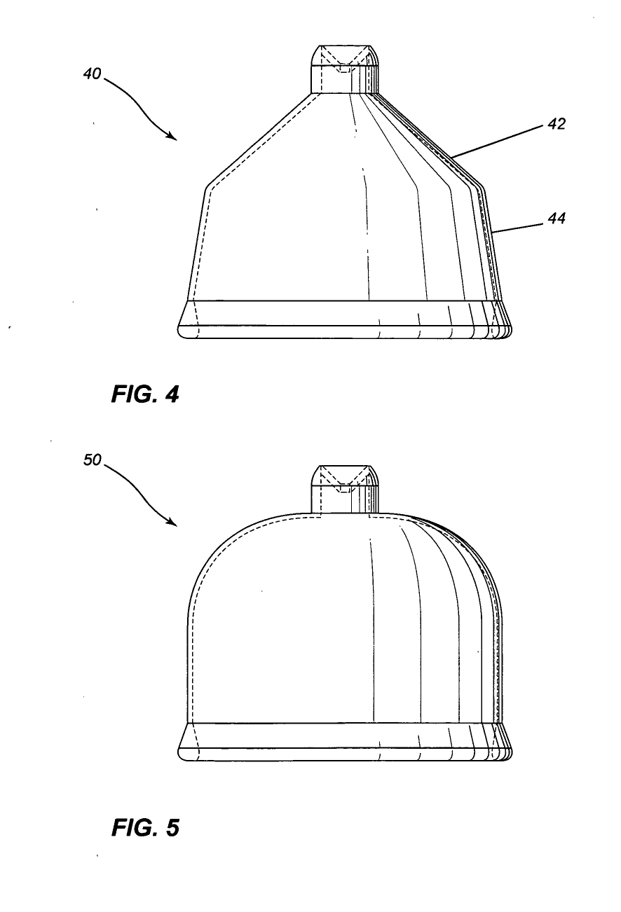

The device is used in conjunction with an air gun as illustrated in FIG. 3 and wherein air gun 26 has a body 28 with a connection 30 for receiving compressed air from a supply. The air gun includes a trigger 32 and an outlet conduit 34.

As will be noted, outlet conduit 34 is placed to extend through aperture 16 and into the interior of device 10.

In operation, the device 10 is placed over the surface to be cleaned and trigger 32 is pressed. The compressed air will blow out of outlet conduit 34 and any small particles on the surface being cleaned will tend to collect in the upper portions of device 10 from where it may be removed.

Device 40 is similar except that it has a single outwardly tapering upper wall section 42 and a substantially vertical wall section 44.

In the embodiment of FIG. 5, wall section 50 is of a domed shaped configuration.

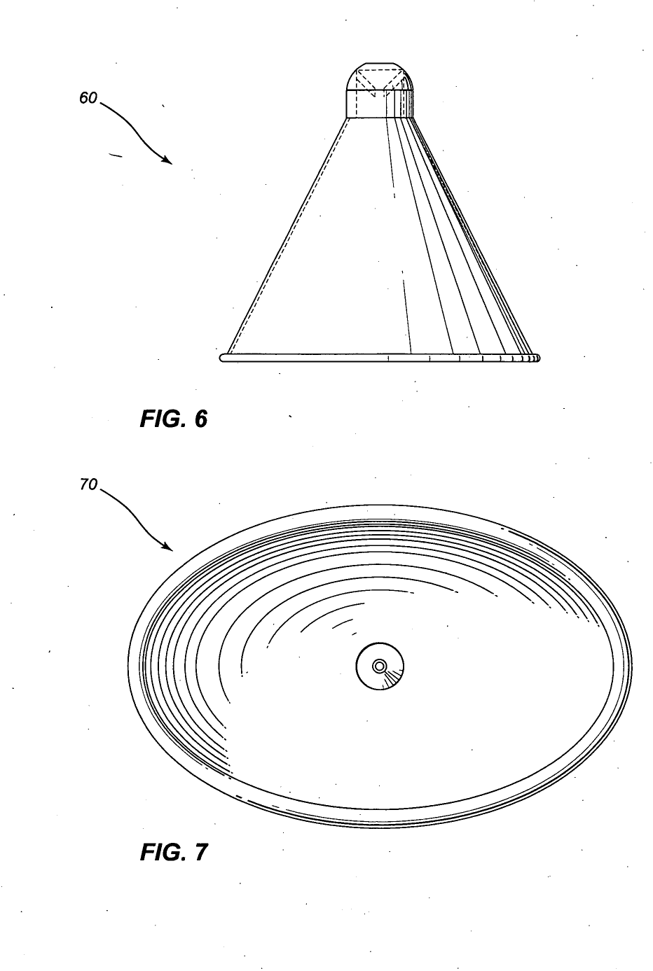

In the embodiment of FIG. 6, wall section 60 has an overall frustraconical configuration.

In the embodiment of FIG. 7, wall section 70 may have a bell shaped outline as shown in FIG. 5, but with an oval base.

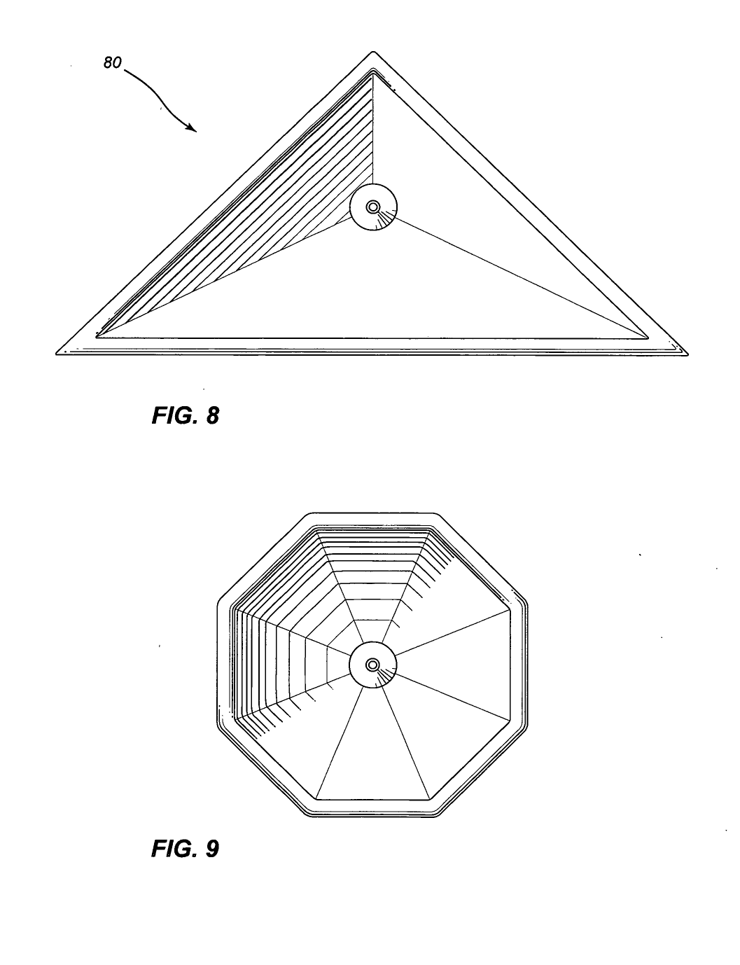

In the embodiment of FIG. 8, a substantially triangular configuration is utilized for device 80.

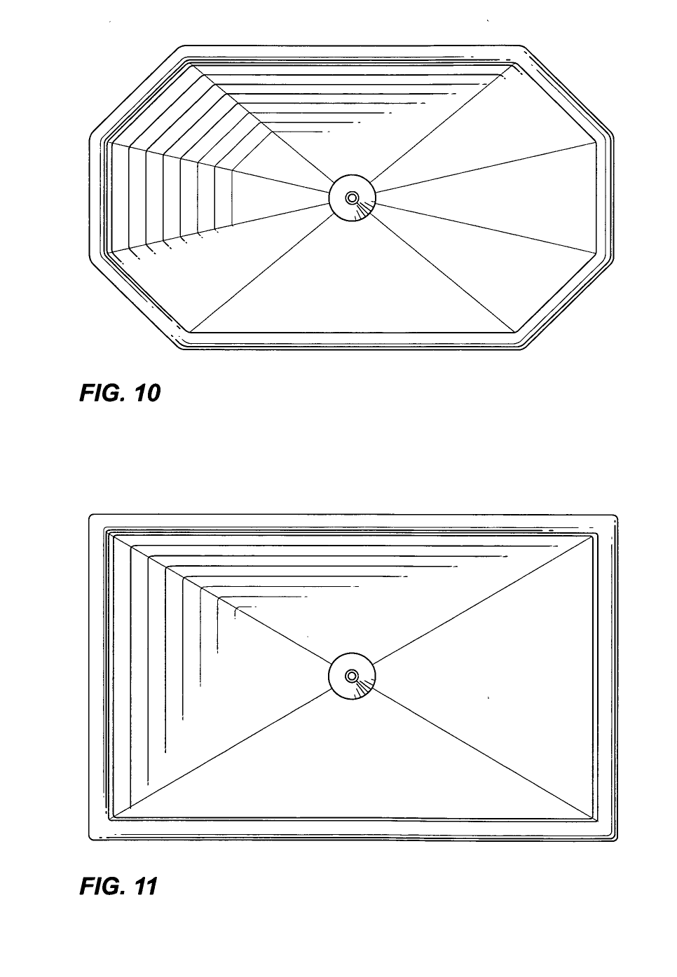

In FIG. 9, an octagonal configuration is employed while in FIG. 10 a hexagonal configuration having two longer sides is shown.

Finally, in FIG. 11, a rectangular configuration is illustrated.

It will be understood that the above described embodiments are for purposes of illustration only and that changes and modifications may be made thereto without departing from the spirit and scope of the invention.

I claim:

1. In combination, an air gun and an accessory therefore, said accessory comprising:
a flexible member having an outer wall, a neck, and a base;
a first opening in said neck and a second opening in said base, said second opening being substantially larger than said first opening, said air gun extending through said first opening.

2. The combination of claim 1 wherein said outer wall is formed of a rubber material.

3. The combination of claim 1 wherein said outer wall is formed of a polymeric material.

4. The combination of claim 1 wherein said outer wall has a stepped configuration.

5. The combination of claim 1 wherein said accessory has an outer wall comprised of a first straight wall section and a second straight wall section, said first straight wall section extending outwardly from said neck and said second straight wall section extending downwardly from said first straight wall section at a lesser angle than said first straight wall section.

6. The combination of claim 1 wherein said outer wall has a bell shaped configuration.

7. The combination of claim 1 wherein said outer wall is substantially straight.

8. The combination of claim 1 wherein said base has a general elliptical configuration.

9. The combination of claim 1 wherein said base has a generally triangular configuration.

10. The combination of claim 1 wherein said base has a substantially rectangular configuration.

11. The combination of claim 1 wherein said base has an octagonal configuration.

12. The combination of claim 1 wherein said first opening is sized to retain said accessory on said air gun.

13. An accessory for an air gun, said accessory comprising:
a flexible member having an outer wall, a neck, and a base;
a first opening in said neck and a second opening in said base, said second opening being substantially larger than said first opening.

14. A method for cleaning particulate matter from a surface comprising the steps of:
supplying an air gun;
placing a flexible member about an end of said air gun, said flexible member having a neck and a base, a first opening in said neck through which said air gun extends, and a second opening in said base, said second opening being substantially larger than said first opening; and
operating said air gun while keeping said second opening proximate the surface to be cleaned such that said particulate matter will be forced upwardly within said flexible member.
